(19) United States
(12) Patent Application Publication
(10) Pub. No.: US 2009/0311024 A1
(43) Pub. Date: Dec. 17, 2009

(54) SYSTEM AND METHOD FOR MONITORING AND DETERMINING THE AMOUNT OF RIBBON ON A SUPPLY SPOOL USED IN A PRINTER

(76) Inventors: Brent A. Bandholz, Hubertus, WI (US); Peter G. Ross, Germantown, WI (US)

Correspondence Address: QUARLES & BRADY LLP, 411 E. WISCONSIN AVENUE, SUITE 2040, MILWAUKEE, WI, 53202-4497, US

(21) Appl. No.: 12/482,542

(22) Filed: Jun. 11, 2009

Related U.S. Application Data
(60) Provisional application No. 61/061,382, filed on Jun. 13, 2008.

(51) Int. Cl. B41J 33/00

(52) U.S. Cl. 400/223

(57) ABSTRACT

A system and method is disclosed for monitoring and determining the amount of ribbon on a supply spool used in a printer. The system and method monitor the rotation of a drive motor to determine a change in useful life that is then used to update the ribbon cartridge useful life that is stored on a ribbon cartridge memory device of the ribbon cartridge. Rotation of the supply spool or take-up spool may be used to estimate the ribbon cartridge useful life when the stored ribbon cartridge useful life is undefined or inaccurate.

### CROSS REFERENCES TO RELATED APPLICATIONS

This application claims priority to U.S. provisional application No. 61/061,382 filed Jun. 13, 2008, which is hereby incorporated by reference as if fully set forth herein.

### STATEMENT REGARDING FEDERALLY SPONSORED RESEARCH

Not Applicable.

### BACKGROUND OF THE INVENTION

The present invention relates to a system and method for monitoring and determining the amount of ribbon on a supply spool used in a printer, and more particularly to a method and system of storing a ribbon cartridge useful life that is updated based primarily in response to rotation of an associated drive motor.

Most printers incorporate a cartridge that is depleted during the printing process. As a result, many techniques have been disclosed to monitor or estimate the remaining useful life of a cartridge. Certain types of printers, however, operate in a manner making the monitoring of the cartridge more challenging. For example, the ribbon cartridge for use in a thermal transfer printer includes a supply spool and a take-up spool. A ribbon is rotatably wound between the supply spool and the take-up spool such that rotation of the supply spool and the take-up spool results in the ribbon being transferred between the spools, with the direction of ribbon transfer dependent on the direction of rotation of the spools.

Thermal transfer printers present unique challenges related to monitoring the remaining useful life of a ribbon cartridge. For example, during printing the ribbon is transferred downstream from the supply spool to the take-up spool with ink being removed from the ribbon by the print head, therefore reducing the remaining useful life. However, because the ribbon and the print media fed through the printer move in substantially unison the ribbon may be transferred downstream before or after the printing process, such as when the printer is aligning the print head with a desired print line of the print media. As a result, no ink is removed from the ribbon, yet the remaining useful life of the ribbon cartridge is nonetheless reduced. Additionally, the ribbon may be transferred upstream from the take-up spool to the supply spool when a print media is being back-fed by a drive roller. Thus, the useful life of the ribbon cartridge has been increased due to the upstream travel of the ribbon.

Given the unique and sophisticated interactions between print media and the media used on the ribbon (e.g., ink), it is not uncommon for a ribbon cartridge to be removed from a printer prior to the end of the useful life of the ribbon cartridge, presenting yet a further challenge in any attempt to accurately monitoring the remaining useful life of a ribbon cartridge. Moreover, installing a partially expended ribbon cartridge results in an undefined remaining useful life of the ribbon cartridge. Other undesirable events, such as a loss of printer power or corrupt data, can also result in the remaining useful life of the ribbon cartridge being undefined.

In light of the above challenges and considerations, a need exists for a system and method for monitoring and determining the amount of ribbon on a supply spool used in a printer.

### SUMMARY OF THE INVENTION

The present invention generally provides a system and method of monitoring and determining the amount of ribbon on a supply spool used in a printer. The system and method monitors the rotation of a drive motor to determine a change in useful life that is then used to update the ribbon cartridge useful life stored on a ribbon cartridge memory device of the ribbon cartridge.

In one aspect, the present invention provides a method of monitoring and determining the amount of ribbon on a supply spool used in a printer, comprising the steps of providing a ribbon cartridge having a ribbon cartridge memory device storing a ribbon cartridge useful life. The ribbon cartridge further comprises a supply spool rotatably coupled to the ribbon cartridge, a take-up spool rotatably coupled to the ribbon cartridge, and a ribbon coupled to the supply spool and the take-up spool such that the ribbon can be selectively transferred between the supply spool and the take-up spool. The method includes the step of providing a printer for receiving the ribbon cartridge. The printer further comprises a print head for engaging the ribbon and printing to a print media, a drive roller for driving the print media upstream and downstream relative to the print head, and a drive motor operationally coupled to at least one of the supply spool, take up spool, and drive roller. The method includes the steps of monitoring the drive motor during transfer of the ribbon between the supply spool and the take-up spool, determining a change in useful life based on monitoring the drive motor, and updating the ribbon cartridge useful life by adjusting the ribbon cartridge useful life in accordance with the change in useful life.

In another aspect, the invention provides a method of monitoring and determining the amount of ribbon on a supply spool used in a printer, comprising the steps of providing a ribbon cartridge having a supply spool, a take-up spool, and a ribbon cartridge memory device storing a ribbon cartridge useful life, and providing a printer for receiving the ribbon cartridge having a drive motor operationally coupled to the printer to drive at least one of the supply spool, the take-up spool, and a drive roller. The method further includes the steps of monitoring a rotation of the drive motor, determining a change in useful life based on monitoring the rotation of the drive motor, and updating the ribbon cartridge useful life by adjusting the ribbon cartridge useful life in accordance with the change in useful life.

In a further aspect, the present invention provides a system for monitoring and determining the amount of ribbon on a supply spool used in a printer. The system includes a ribbon cartridge having a ribbon cartridge memory device storing a ribbon cartridge useful life. The ribbon cartridge further comprises a supply spool rotatably coupled to the ribbon cartridge, a take-up spool rotatably coupled to the ribbon cartridge, and a ribbon coupled to the supply spool and the take-up spool such that the ribbon can be selectively transferred between the supply spool and the take-up spool. The system further includes a printer for receiving the ribbon cartridge. The printer comprises a print head for engaging the ribbon and printing to a print media, a drive roller for driving the print media upstream and downstream relative to the print head, a drive motor operationally coupled to at least one of the supply spool, take up spool, and drive roller, and a controller operationally coupled to the drive motor and the ribbon cartridge memory device. The controller monitors the drive motor during transfer of the ribbon between the supply spool and the take-up spool to calculate a change in useful life based on rotation of the drive motor and then updates the ribbon cartridge useful life by adjusting the ribbon cartridge useful life in accordance with the change in useful life.

These and still other aspects of the present invention will be apparent from the description that follows. In the detailed description, a preferred example embodiment of the invention will be described with reference to the accompanying drawings. This embodiment does not represent the full scope of the invention; rather the invention may be employed in other embodiments. Reference should therefore be made to the claims herein for interpreting the breadth of the invention.

### BRIEF DESCRIPTION OF THE DRAWINGS

FIG. 1 is an isometric view of a printer incorporating the present invention;

FIG. 2 is an isometric view of a print assembly shown removed from the printer of FIG. 1;

FIG. 3 is an isometric view of the print assembly of FIG. 2 shown with the upper frame in the opened position;

FIG. 4 is a partial section view along line 4-4 of FIG. 2;

FIG. 5 is a partial isometric detail view showing the drive train of printer of FIG. 1;

FIG. 6 is an isometric view of the print assembly of FIG. 2;

FIG. 7 is partial isometric detail view showing a portion of a supply spool in accordance with the present invention;

FIG. 8 is a section view along line 8-8 of FIG. 7;

FIG. 9 is a partial exploded view showing the supply spool and optical sensor exploded from the print assembly;

FIG. 10 is a partial isometric view of a ribbon cartridge and circuit board;

FIG. 11 is an exploded view of the ribbon cartridge of FIG. 10 showing the ribbon cartridge memory device; and

FIG. 12 is a simplified schematic showing selected components of the printer.

### DETAILED DESCRIPTION OF THE PREFERRED EXAMPLE EMBODIMENT

The preferred example embodiment of the invention will be described in relation to a thermal transfer printer. However, the present invention is equally applicable to other types and styles of printers that may benefit from the incorporation of a system and method to monitor and determine the remaining useful life of a ribbon cartridge.

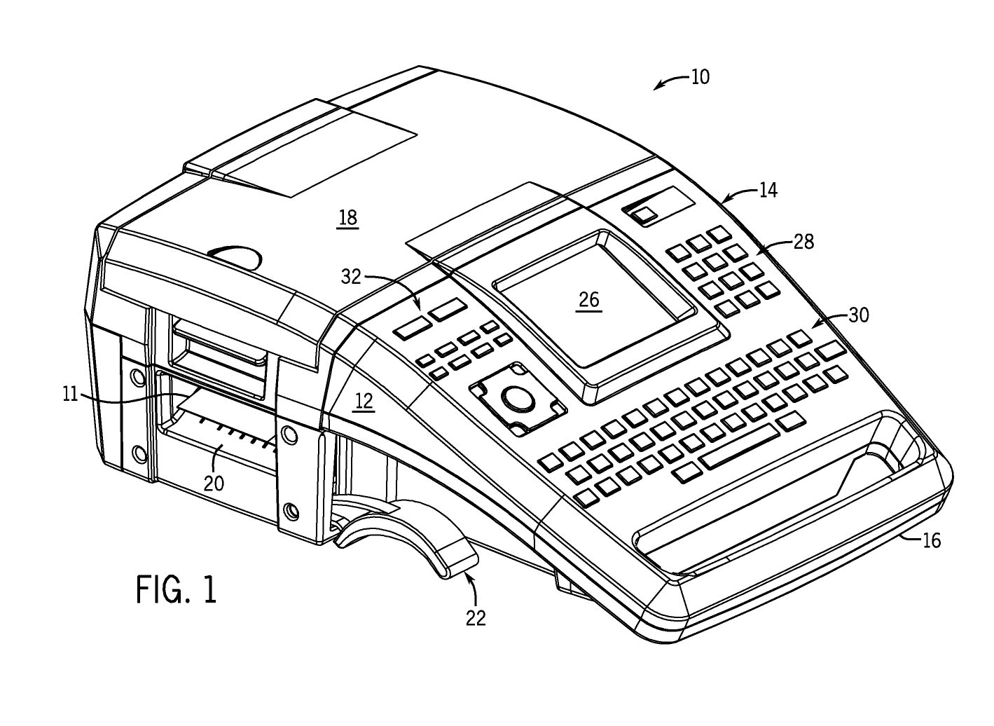

With initial reference to FIG. 1, a printer 10 capable of printing on a print media 11 (e.g., adhesive labels, plain paper, plastic transparencies, and the like) is shown. The printer 10 has a body 12 including a user interface 14 for communication between a user and the printer 10, a handle 16 for easy transport of the printer 10, a moveable cover 18 for accessing a print assembly 34 contained within the body 12, a print slot 20 from which the printed-on print media 11 exits from the printer 10, and a cutting assembly 22 for assisting in the cutting or separation of the print media 11.

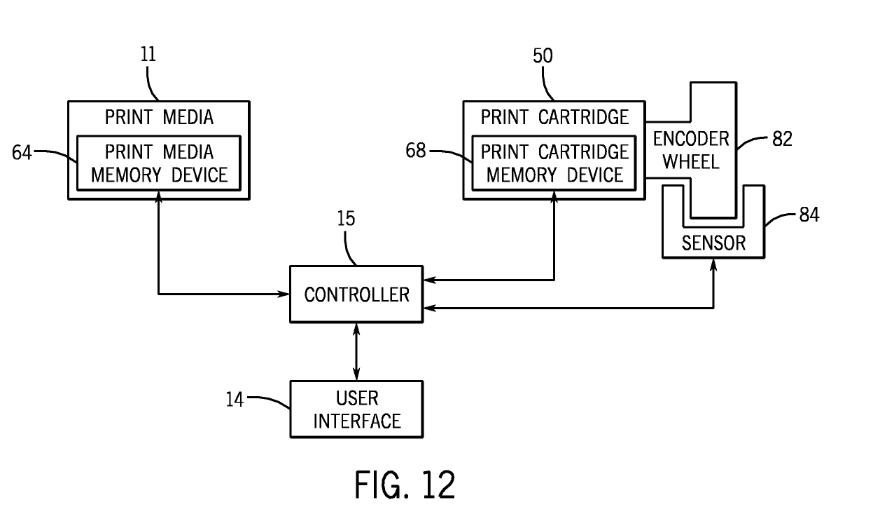

The user interface 14 may include, but is not limited to, a display 26 for displaying information, a keypad 28 and a keyboard 30 for entering data, and function buttons 32 that may be configured to perform various typical printing functions (e.g., cancel print job, advance print media, and the like) or be programmable for the execution of macros containing preset printing parameters for a particular type of print media 11. The user interface 14 may be supplemented by or replaced by other forms of data entry or printer control such as a separate data entry and control module linked wirelessly or by a data cable operationally coupled to a computer, a router, or the like. Additionally, the user interface 14 is operationally coupled to a controller 15 (shown in FIG. 12) for controlling the operation of the printer 10, in addition to other functions discussed below in greater detail.

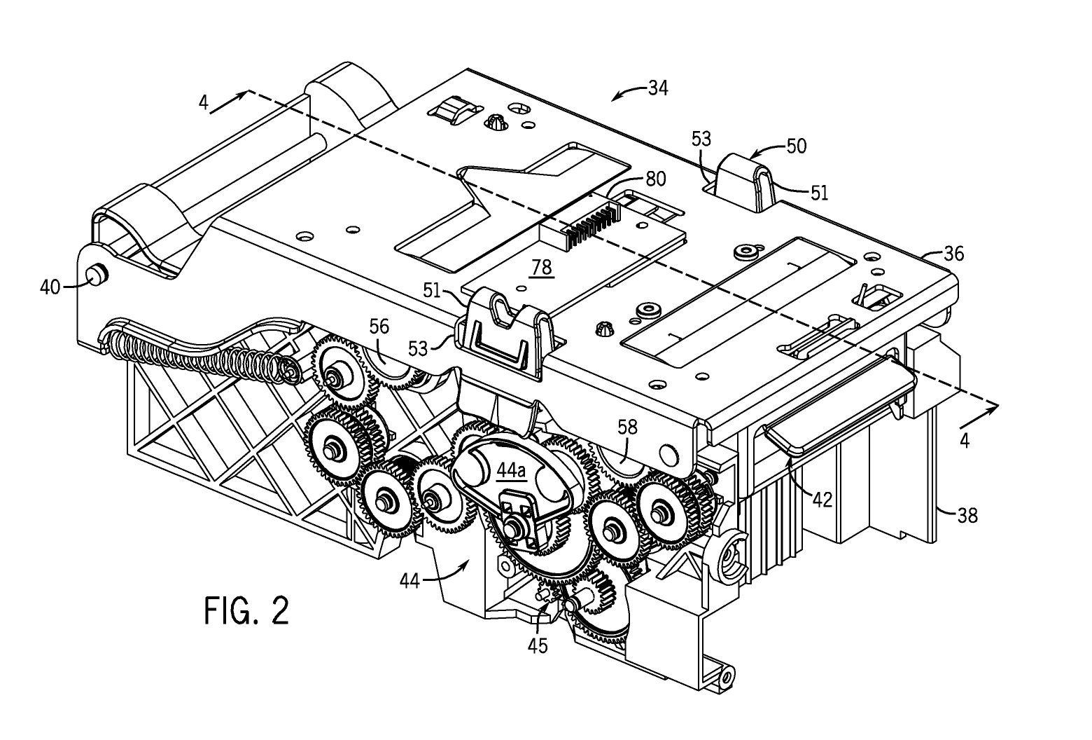

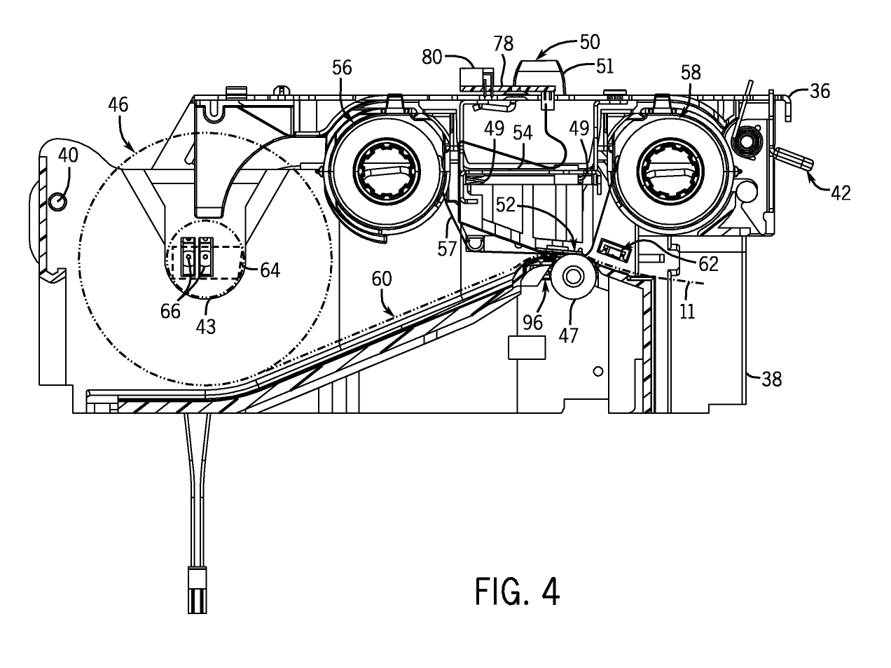

Referring now to FIG. 2, the print assembly 34 is shown after having been removed from the inside of the printer 10. The print assembly 34 includes an upper print frame 36 and a lower print frame 38. On one end, the upper print frame 36 and the lower print frame 38 are pivotally connected at a hinge 40. On the opposite end, a latch 42 releasably secures the upper print frame 36 and the lower print frame 38 together in the closed position. Additionally, a drive train 44 is mounted on the side of the lower print frame 38 for transmitting rotation of a drive motor 45 to a drive roller 47 (shown best in FIG. 4) and a ribbon cartridge 50. In the preferred example embodiment described with reference to a thermal transfer printer 10, the drive roller 47 is preferably a platen roller. The structure and operation of the print assembly 34 and drive train 44 are described in related U.S. Application No. 61/061,432, filed Jun. 13, 2008, which is hereby incorporated by reference as if fully set forth herein. In general, however, the drive motor 45 drives the drive direction assembly 44a. The drive direction assembly 44a in turn drives the drive roller 47 and ribbon cartridge 50, through a series of friction and idler gears, in either an upstream direction (as shown) or a downstream direction, depending on the orientation of the drive direction assembly 44a.

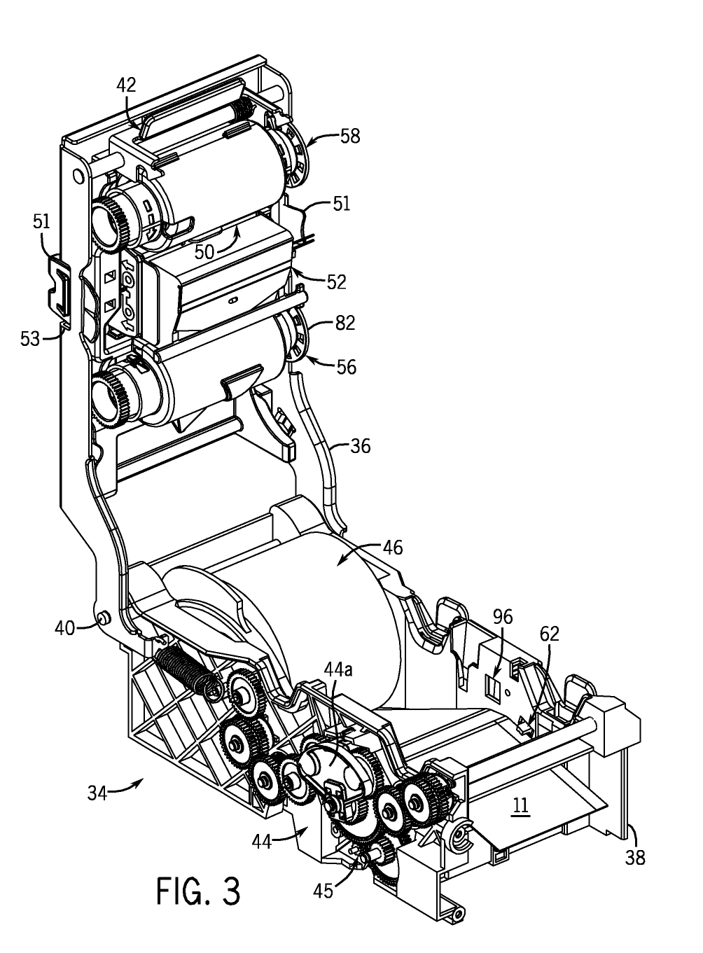

With additional reference to FIGS. 3 and 4, the print assembly 34 is shown in FIG. 3 after the latch 42 has been released to allow the upper print frame 36 to pivot away from the lower print frame 38 into the opened position, thus exposing the interior of the print assembly 34. A roll assembly 46 is located within the lower print frame 38 and carries a web of the print media 11 about a media spool 43. As is appreciated by one skilled in the art, the roll assembly 46 may comprise a variety of print media 11, such as adhesive labels or plain paper.

Attached to the upper print frame 36 are the ribbon cartridge 50 and a print head 52. The print head 52 is moveably coupled to a bracket 54 such that the print head 52 is biased toward the drive roller 47 by a group of springs 49 when the upper print frame 36 is in the closed position (shown best in FIG. 4). The ribbon cartridge 50 is secured to the upper print frame 36 by a pair of clips 51 that extend from the ribbon cartridge 50 and snap-fit into a pair of notches 53 formed in the upper print frame 36.

The ribbon cartridge 50 includes a supply spool 56 and a take-up spool 58 that are rotatably coupled to a ribbon 57. The ribbon 57 (shown only in FIG. 4 for clarity) can be unwound from the supply spool 56 during printing, fed downstream toward the print head 52, and then wound to the take-up spool 58. In certain circumstances, the ribbon 57 can be unwound from the take-up spool 58, back-fed upstream toward the supply spool 56, and rewound to the supply spool 56.

With specific reference to FIG. 4, the engagement between the print head 52 and the drive roller 47 establishes a nip pressure on the print media 11 and the ribbon 57 as each passes between the print head 52 and the drive roller 47. The nip pressure ensures a sufficient amount of friction between the print media 11/ribbon 57 and the drive roller 47 to allow the drive roller 47 to translate the print media 11 and ribbon 57 downstream and upstream of the print head 52 as required.

During printing, the print media 11 moves along a path 60 (best shown in FIG. 4) that extends adjacent the print head 52 and drive roller 47. As the print media 11 and ribbon 57 pass between the print head 52 and the drive roller 47, the print head 52 is selectively heated to apply heat to the ribbon 57 causing the print material (e.g., ink) to be transferred from the ribbon 57 to the print media 11. The print head 52 includes the various components of a thermal transfer print head, such as heating elements allowing for the selective heating of the print head 52, associated control circuitry, a heat sink for the dissipation of the heat from the print head 52, and the like, that are known to those skilled in the art.

The translation of the print media 11 and the driving of the supply spool 56 and take-up spool 58 are controlled by the controller 15. The controller 15 is also in communication with an upstream sensor 96 and a downstream sensor 62 to detect the presence of the print media 11 along the path 60. As best shown in FIGS. 3 and 4, the upstream sensor 96 is positioned upstream of the drive roller 47 to detect the print media 11 prior to engaging the print head 52. The downstream sensor 62 is positioned downstream of the drive roller 47 to detect the print media 11 and prevent excessive back-feeding of the print media 11 that results in a loss of nip pressure. The upstream sensor 96 and the downstream sensor 62 may be configured to detect the presence of the print media 11 and/or any variation of indices (not shown) thereon, thus allowing the controller 15 to establish the relative position between the print media 11 and the print head 52. Additional detail concerning the upstream sensor 96, downstream sensor 62, and the associated printer control is found in related U.S. Application No. 61/061,412, filed Jun. 13, 2008, which is hereby incorporated by reference as if fully set forth herein.

For the printer 10 to function properly, the ribbon cartridge 50 and the print media 11 must be compatible with each other, and the respective parameters of the ribbon cartridge 50 and the print media 11 must be programmed or known by the controller 15. Without the proper compatibility and configuration, the printer 10 may not operate correctly or produce poor quality prints.

Preferably, the printer 10 automatically determines the compatibility between the ribbon cartridge 50 and the print media 11, and automatically configures certain settings of the printer 10 based on the type of ribbon cartridge 50 and print media 11 installed. To facilitate this automatic compatibility and configuration the print media 11 and ribbon cartridge 50 provide the requisite information to the controller 15.

The print media 11 includes a print media memory device 64 storing print media data that corresponds to the particular print media 11. The print media data may include, for example, the ribbon cartridge compatibility (e.g., what ribbon cartridges perform best with the particular print media 11), print media type, print media dimensions, print media layout, print media optimum print speed, print media optimum energy requirements, and the like.

The print media memory device 64 may be located at any location on the roll assembly 46, such as in a spool (not shown). The print media memory device 64 preferably communicates with the printer 10 via media memory contacts 66 operationally coupled to the controller 15. To ensure consistent communication between the print media memory device 64 and the media memory contacts 66, the roll assembly 46 may include a bearing that allows relative rotation between an outer sleeve and an inner sleeve (not shown) such that the media memory contacts 66 maintain the orientation shown in FIG. 4. Alternatively, the print media memory device 64 may communicate with the controller 15 wirelessly (e.g., via radio frequency) or any other suitable technique.

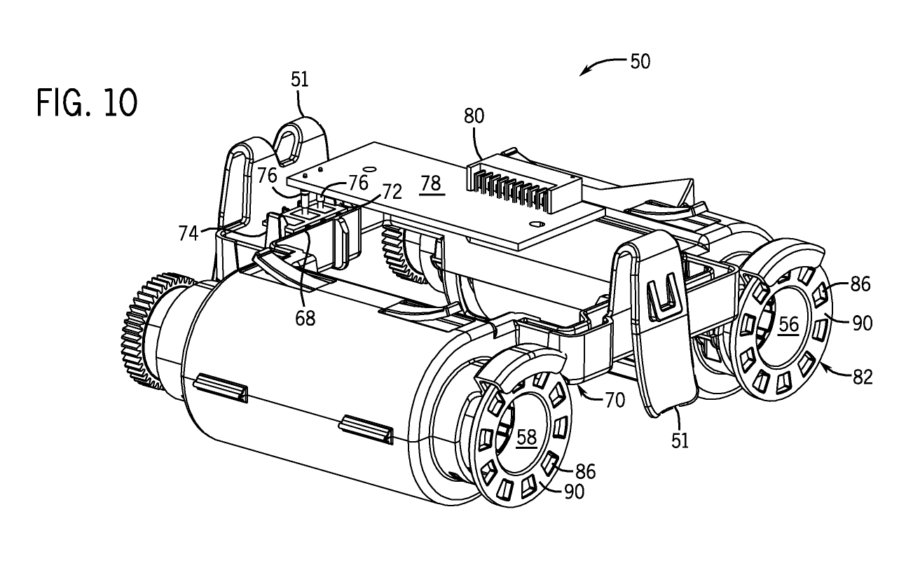

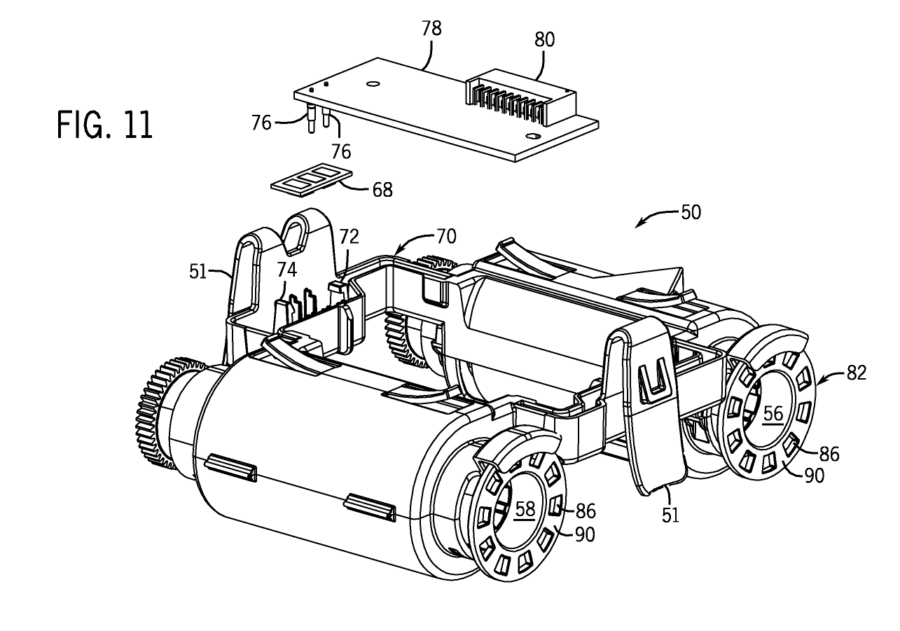

Similarly, the ribbon cartridge 50 (best shown in FIGS. 10 and 11) has a ribbon cartridge memory device 68 storing ribbon cartridge data that corresponds to the ribbon cartridge 50. The ribbon cartridge data may include, for example, the ribbon cartridge type, ribbon cartridge capacity, ribbon cartridge color, print media compatibility, and the like. The ribbon cartridge memory device 68 may be located anywhere on the ribbon cartridge 50 or directly on the supply spool 56 or take-up spool 58. Preferably, the ribbon cartridge memory device 68 is located such that if the ribbon cartridge memory device 68 is removed from the printer 10, the ribbon cartridge data stored thereon is also removed. As a result, re-inserting the ribbon cartridge 50 back into the printer 10 (i.e., the same printer 10 or a different printer) allows the controller 15 to query the ribbon cartridge memory device 68 for the ribbon cartridge data that reflects the cumulative use history of the ribbon cartridge 50 (discussed in more detail below).

In the preferred example embodiment, the ribbon cartridge memory device 68 is releasably secured to the ribbon cartridge 50. The ribbon cartridge 50 includes a housing 70 that defines a retainer 72 and a clip 74 for restraining the ribbon cartridge memory device 68 to the housing 70. The ribbon cartridge memory device 68 is operationally connected to the controller 15 via a pair of spring-loaded cartridge memory contacts 76 that are coupled to a circuit board 78. The circuit board 78 is ultimately in communication with the controller 15 via connector 80. Given the removable coupling of the ribbon cartridge memory device 68 from the ribbon cartridge 50, the ribbon cartridge memory device 68 may be removed, reprogrammed, and reused on a new ribbon cartridge 50. While the ribbon cartridge 50 described includes a housing 70, one skilled in the art will appreciate that the ribbon cartridge 50 may comprise a supply spool 56 and a take-up spool 58 without the need for a generally convenient housing 70.

The incorporation of the print media memory device 64 in relation to the print media 11 and the incorporation of the ribbon cartridge memory device 68 in relation to the ribbon cartridge 50, allows the controller 15 to automatically determine compatibility between the print media 11 and ribbon cartridge 50, and to automatically configure the printer 10 accordingly. Upon inserting the print media 11 and the ribbon cartridge 50 into the printer 10, the controller 15 reads the print media memory device 64 and the ribbon cartridge memory device 68. The controller 15 then compares the print media data and the ribbon cartridge data to determine if compatibility exists between the print media 11 and the ribbon cartridge 50. The comparison performed by the controller 15 may be simply matching model numbers, or more complex, such as comparing a set of print media parameters to a set of ribbon cartridge parameters and applying preset logic to determine if compatibility exits.

If the controller 15 determines that compatibility exists between the print media 11 and the ribbon cartridge 50, the controller 15 may then use the print media data and the ribbon cartridge data to prepare a print parameters data set in a controller memory device (not shown) that can be used by the controller 15 and/or passed to printing software to aid in formatting the data to be printed by the printer 10. One skilled in the art will appreciate the various data that can be contained in the print media data and the ribbon cartridge data, and that can be used to format the print parameters data set.

In the event that the controller 15 determines that the print media 11 and ribbon cartridge 50 are incompatible, or indeterminate, the controller 15 may query the user or require that the print parameters be manually entered via the user interface 14. In any event, the controller 15 may be configured to verify the integrity of the print media data and the ribbon cartridge data. If corrupt data is detected, the controller 15 may provide feedback via the user interface 14.

The ribbon cartridge memory device 68 can further store a ribbon cartridge useful life (e.g., the remaining print capacity of the supply spool 56 in the example embodiment). The ribbon cartridge useful life is preferably a numeric value representing the linear length (e.g., inches, centimeters, and the like) of ribbon 57 wound on the supply spool 56, and is at a maximum value before any ribbon 57 has been used during the printing process. Additionally, the ribbon cartridge memory device 68 may store both the ribbon cartridge useful life in addition to the ribbon cartridge capacity (e.g., the quantity of ribbon on a full ribbon cartridge 50). Provided an updated (i.e., current) ribbon cartridge useful life and the ribbon cartridge capacity, the controller 15 can determine the percentage of ribbon 57 remaining (as quantified in the ribbon cartridge useful life) relative to the ribbon cartridge capacity, allowing a graphical representation of the remaining percentage of ribbon 57 to be shown on the display 26. Even after removing and reinserting the ribbon cartridge 50, the percentage of remaining ribbon 57 may be determined and displayed as the current ribbon cartridge useful life and original ribbon cartridge capacity are stored on the ribbon cartridge memory device 68. In light of this disclosure, one skilled in the art will appreciate the various units or metrics available to represent the ribbon cartridge useful life and ribbon cartridge capacity in accordance with the invention.

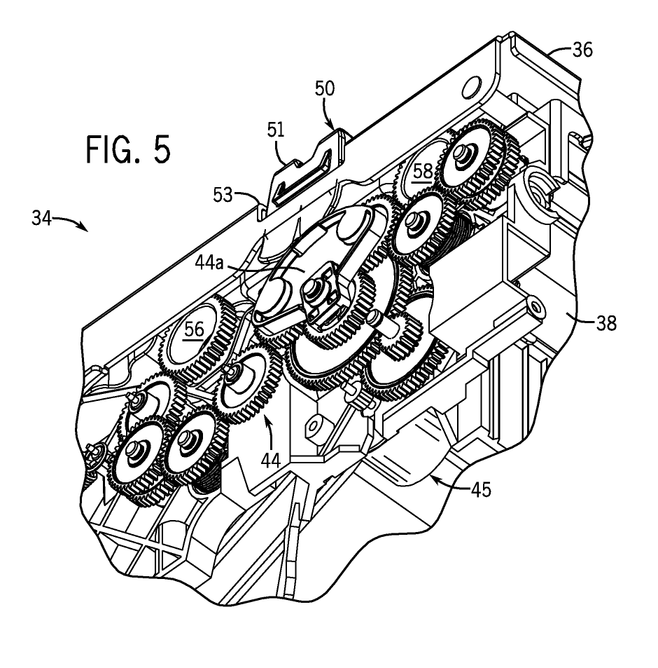

Returning to FIGS. 4 and 5, the remaining useful life of the ribbon cartridge 50 can be updated by monitoring the drive motor 45 as ribbon 57 is transferred between the supply spool 56 and the take-up spool 58. Also, the direction of the drive motor 45 also influences the adjustment of the ribbon cartridge useful life. Generally, rotation of the drive motor 45 causing downstream rotation of the supply spool 56 results in a reduction to the ribbon cartridge useful life, alternatively, rotation of the drive motor 45 causing upstream rotation of the supply spool 56 (such as during back-feeding of the print media 11) results in an increase to the ribbon cartridge useful life.

The linear movement or translation of the ribbon 57 between the supply spool 56 and take-up spool 58 can be determined by monitoring the drive motor 45. Specifically, use of a stepper motor as the drive motor 45 allows the drive motor 45 to rotate a discrete, controlled number of “steps.” Each “step” is equivalent to a uniform fraction of a full rotation of the drive motor 45 (e.g., one “step” may equate to 1/50 of a full revolution of the drive motor 45). In addition, each drive train 44 configuration will establish a gear ratio between the drive motor 45 and the drive roller 47 (e.g., fifty rotations of the drive motor 45 may equate to one rotation of the drive roller 47), thus with knowledge of the diameter of the drive roller 47 the linear travel of the drive roller 47, and hence ribbon 57, over a number of drive motor 45 “steps” in a given time period can be calculated by the controller 15. As a result, the accumulation and summing of the drive motor 45 “steps” can be converted to a linear distance by the controller 15 that equates to a change in useful life of the ribbon cartridge 50 due to the transfer of ribbon 57 between the supply spool 56 and the take-up spool 58.

One skilled in the art will appreciate the variations available for calculating and converting the rotation of the drive motor 45. For example, the ribbon cartridge useful life may be stored on the ribbon cartridge memory device 68 as a number of rotations of the drive motor 45 “steps.” Thus, the ribbon cartridge useful life is adjusted by the controller 15 according to the “steps,” accounting for drive direction (i.e., from the supply spool 56 to the take-up spool 58 or the reverse), detected by the controller 15.

The above method operates under the assumptions that the print media 11 and ribbon 57 mate and engage at the interface between the drive roller 47 and the print head 52 (best shown in FIG. 4), the print media 11 is driven by the drive roller 47 (preferably a platen roller), and the engagement between the ribbon 57 and print media 11 and between the print media 11 and the drive roller 47 are substantially free from slip (i.e., there is no relative movement between the ribbon 57, print media 11, and drive roller 47 proximate the print head 52 but for the rotation of the drive roller 47). Slipping between the ribbon 57, print media 11, and/or drive roller 47 will introduce error into the calculation of the ribbon cartridge useful life.

In operation, and with additional reference to FIG. 12, the amount of ribbon 57 remaining on the supply spool 56 of the ribbon cartridge 50 is monitored and determined as follows. The ribbon cartridge memory device 68 is preprogrammed with a starting or maximum ribbon cartridge useful life, or if a pre-used ribbon cartridge 50, the most recent ribbon cartridge useful life. Once the ribbon cartridge 50 is inserted into the printer 10, the controller 15 retrieves the ribbon cartridge useful life from the ribbon cartridge memory device 68. During printing, the drive motor 45 is monitored by the controller 15, specifically the direction and number of “steps” in each direction. The direction and number of “steps” are cumulatively summed by the controller 15 to calculate a change in useful life. As noted above, the controller 15 performs any necessary conversions to ensure that the cumulative “steps” are in the same units as the ribbon cartridge useful life. The controller 15 then calculates the updated ribbon cartridge useful life by adding or subtracting from the ribbon cartridge useful life as appropriate.

The ribbon cartridge useful life is updated and stored in the ribbon cartridge memory device 68 as programmed. That is, the controller 15 may update the ribbon cartridge useful life stored in the ribbon cartridge memory device 68 on a substantially continual basis, after a predefined time period, after a predefined number of “steps” of the drive motor 45, or any other control logic.

In some circumstances, the ribbon cartridge useful life may be undefined, unreadable, inaccurate, or the like. This could be the result of a defective ribbon cartridge memory device 68, a failure of the cartridge memory contacts 76, manual winding or unwinding of the ribbon 57, or various other undesirable issues. In these circumstances, it is desirable to have an accurate method to estimate the ribbon cartridge useful life. The present invention discloses a supply spool 56 that incorporates an encoder wheel 82 that, when monitored with a spool sensor 84, establishes an estimated ribbon cartridge useful life.

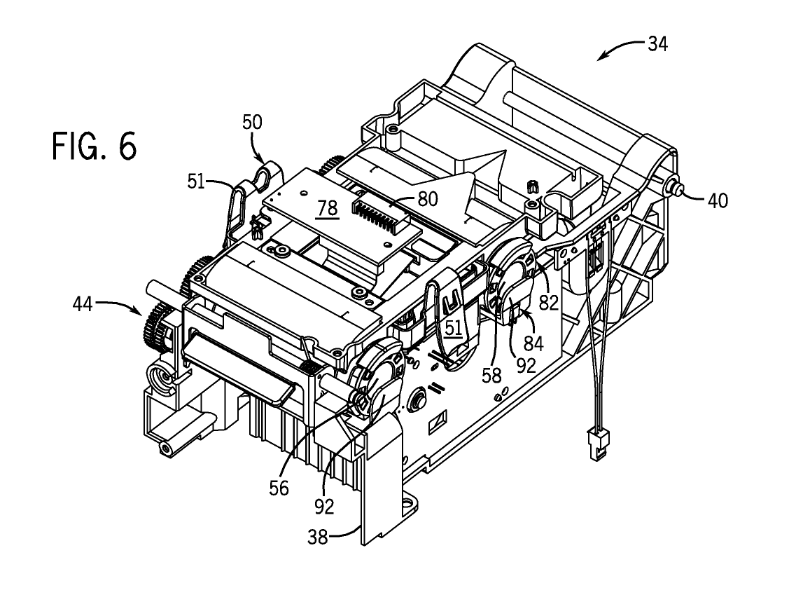

With specific reference to FIGS. 6-9 and 12, the integration of the encoder wheel 82 and spool sensor 84 is described in greater detail. In the example embodiment, the encoder wheel 82 is shown as integrally formed with the supply spool 56 (and the take-up spool 58 for ease of manufacturing and addition of another spool sensor 84 detecting the rotation of the take-up spool 58, if desired), however, the encoder wheel 82 can be a separate component configured to rotate when the supply spool 56 rotates, although not necessarily at the same rate.

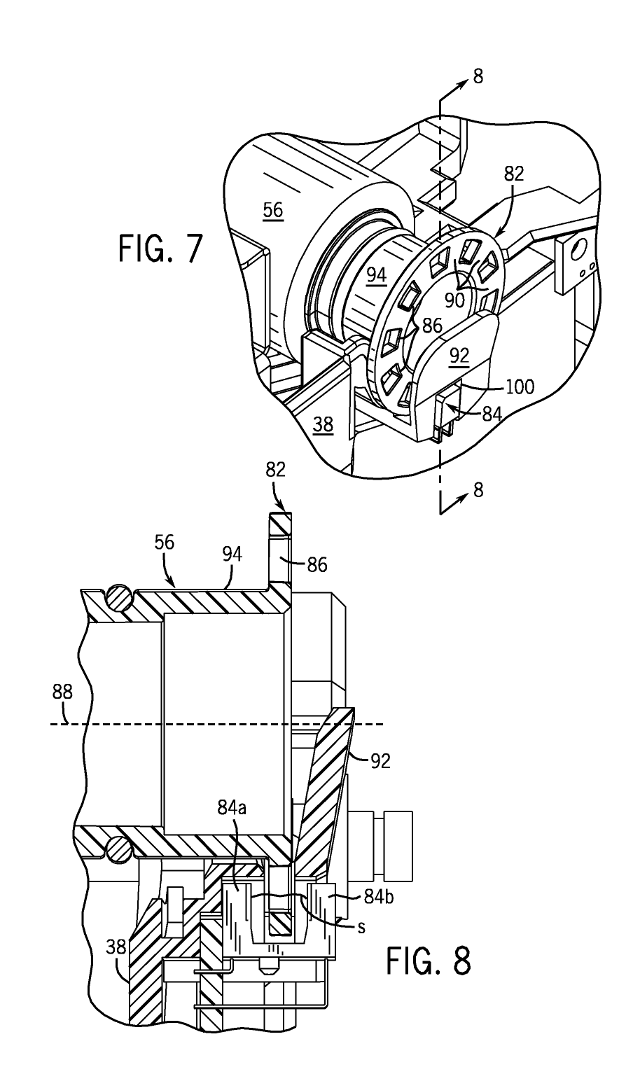

Turning to FIG. 7, the encoder wheel 82 is a round flat plate with several equidistant slots 86 dispersed radially about an axis 88 (shown only in FIG. 8) of the encoder wheel 82. The slots 86 are defined by ribs 90 that are preferably substantially the same width as the slots 86. When the ribbon cartridge 50, and thus supply spool 56 captured in the housing 70, is oriented in the closed position (substantially as shown in FIG. 6), the encoder wheel 82 is located proximate a generally U-shaped support bracket 92. A necked portion 94 of the supply spool 56 rides in a generally U-shaped cradle 98 during rotation of the supply spool 56.

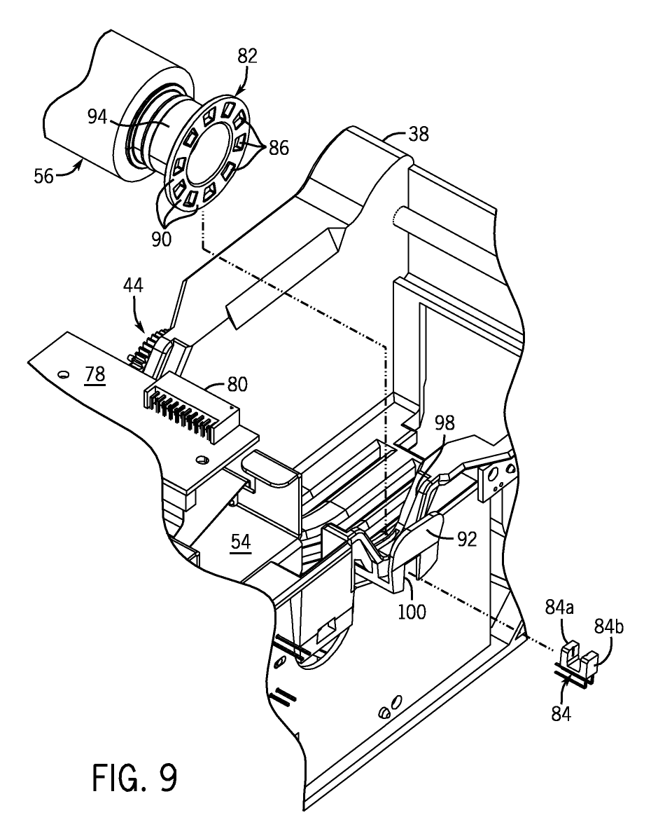

The spool sensor 84 is secured in a notch 100 formed in the base of the support bracket 92. The spool sensor 84 is configured such that as the supply spool 56 and coupled encoder wheel 82 rotate, the controller 15 monitors the spool sensor 84 to detect a change in the line of sight S between the arms 84a, 84b of the spool sensor 84 (shown best in FIGS. 8 and 9) corresponding to the slots 86 and ribs 90 of the encoder wheel 82. Thus, the controller 15 monitors the spool sensor 84 to determine when a transition occurs between a slot 86 and a rib 90.

The information obtained by the controller 15 from the spool sensor 84 can be used in combination with the number of “steps” of the drive motor 45 to establish an estimated ribbon cartridge useful life. As the amount of ribbon 57 on the supply spool 56 decreases, dispensing an equivalent linear segment of ribbon 57 will cause the supply spool 56 to rotate faster. As a result, the number of “steps” of the drive motor 45 required to cause a transition (i.e., for the spool sensor 84 to sense a change between a slot 86 and a rib 90) is reduced as the ribbon cartridge useful life decreases. Therefore, by comparing the number of “steps” of the drive motor 45 that occur between a transition detected by the spool sensor 84, the controller 15 may relate the number of “steps” to an approximation of the remaining ribbon 57 on the supply spool 56. Preferably, the slots 86 and ribs 90 are wide enough to allow a sufficient number of drive motor 45 “steps” to be counted by the controller 15, even as the remaining ribbon 57 on the supply spool 56 is nearly depleted. For any given encoder wheel 82, drive train 44, drive motor 45 configuration, the rotational speed of the supply spool 56 can be mathematically equated to establish an estimated ribbon cartridge useful life with substantial accuracy.

Alternatively, as will be appreciated by one skilled in the art, the rotational speed of the supply spool 56 may be equated directly to an estimated ribbon cartridge useful life, without the use of the “step” information. In this situation, the resolution and accuracy of the estimated ribbon cartridge useful life may be increased by overdriving the encoder wheel 82 and/or increasing the number of slots 86 and ribs 90 in a given area. Moreover, the spool sensor 84 may be used in conjunction with the take-up spool 58 using similar methods described above, either in addition to the spool sensor 84 detecting rotation of the supply spool 56 or alone.

With respect to the rotation of the drive motor 45, one skilled in the art will appreciate the various techniques available to determine the amount of rotation of the drive motor 45 beyond counting the “steps.” For example, a known rotational speed of the drive motor 45 in combination with the period the drive motor 45 is driven may be used to establish the total rotation of the drive motor 45 during a printing cycle. This total rotation may then be correlated to the rotation of the supply spool 56 to establish the ribbon cartridge useful life, a change in useful life, or the estimated ribbon cartridge useful life as described above.

The estimated ribbon cartridge useful life can be used by the controller 15 when the ribbon cartridge useful life is otherwise unknown, inaccurate, or undefined, such as when the ribbon cartridge useful life cannot be read from the ribbon cartridge memory device 68 or the controller 15, after comparing the ribbon cartridge useful life stored on the ribbon cartridge memory device 68 to the estimated ribbon cartridge useful life determined via the encoder wheel 82, determines that the ribbon cartridge useful life is inaccurate. Alternatively, or in addition, the estimated ribbon cartridge useful life may be compared to the ribbon cartridge useful life stored on the ribbon cartridge memory device 68 to verify the accuracy and operation of the overall printer 10. Specifically, the controller 15 may be configured to display an error or informational message to the user via the user interface 14 if no rotation of the supply spool 56 is detected. Depending on the known ribbon cartridge useful life, the controller 15 may indicate that the ribbon cartridge 50 has been depleted if the ribbon cartridge useful life was nearing depletion, or that the ribbon cartridge 50 is jammed or otherwise not functioning correctly if the ribbon cartridge useful life indicated a remaining ribbon cartridge useful life.

In light of the above, the present invention provides a method and system for accurately and efficiently determining the amount of ribbon 57 on the supply spool 56. The method and system further includes updating the ribbon cartridge memory device 68 to reflect changes in the ribbon cartridge useful life and provides techniques to estimate the ribbon cartridge useful life where the ribbon cartridge memory device 68 fails to provide or contain the required accurate data.

While there has been shown and described what is at present considered the preferred embodiment of the invention, it will be obvious to those skilled in the art that various changes and modifications can be made therein without departing from the scope of the invention defined by the following claims. These variations, among others, are contemplated by and within the scope of the present invention.

We claim:

1. A method of monitoring and determining an amount of ribbon on a supply spool used in a printer, comprising the steps of:
providing a ribbon cartridge having a ribbon cartridge memory device storing a ribbon cartridge useful life, the ribbon cartridge further comprising:
a supply spool rotatably coupled to the ribbon cartridge;
a take-up spool rotatably coupled to the ribbon cartridge; and
a ribbon coupled to the supply spool and the take-up spool such that the ribbon can be selectively transferred between the supply spool and the take-up spool;
providing a printer for receiving the ribbon cartridge, the printer further comprising:
a print head for engaging the ribbon and printing to a print media;
a drive roller for driving the print media upstream and downstream relative to the print head; and
a drive motor operationally coupled to at least one of the supply spool, take up spool, and drive roller;
monitoring the drive motor during transfer of the ribbon between the supply spool and the take-up spool;
determining a change in useful life based on monitoring the drive motor; and
updating the ribbon cartridge useful life by adjusting the ribbon cartridge useful life in accordance with the change in useful life.

2. The method of claim 1, wherein the printer is a thermal transfer printer.

3. The method of claim 1, wherein the drive motor is a stepper motor.

4. The method of claim 3, wherein the step of monitoring the drive motor during transfer of the ribbon between the supply spool and the take-up spool further comprises monitoring discrete steps of the stepper motor.

5. The method of claim 4, wherein the step of determining a change in useful life based on monitoring the drive motor comprises summing the discrete steps of the stepper motor.

6. The method of claim 1, further comprising the step of monitoring rotation of at least one of the supply spool and the take-up spool to establish an estimated ribbon cartridge useful life.

7. The method of claim 6, further comprising the step of updating the ribbon cartridge useful life to the estimated ribbon cartridge useful life when the change in useful life is at least one of undefined and inaccurate.

8. The method of claim 1, wherein:
the printer further comprises a display;
the ribbon cartridge memory device further stores a ribbon cartridge capacity; and
the method further comprises the steps of:
determining a remaining percentage of the ribbon cartridge useful life relative to the ribbon cartridge capacity; and
displaying graphically the remaining percentage on the display.

9. A method of monitoring and determining an amount of ribbon on a supply spool used in a printer, comprising the steps of:
providing a ribbon cartridge comprising a supply spool, a take-up spool, and a ribbon cartridge memory device storing a ribbon cartridge useful life;
providing a printer for receiving the ribbon cartridge and comprising a drive motor operationally coupled to the printer to drive at least one of the supply spool, the take-up spool, and a drive roller;
monitoring a rotation of the drive motor;
determining a change in useful life based on the monitoring a rotation of the drive motor; and
updating the ribbon cartridge useful life by adjusting the ribbon cartridge useful life in accordance with the change in useful life.

10. The method of claim 9, wherein drive motor is a stepper motor.

11. The method of claim 10, wherein the step of monitoring the rotation of the stepper motor comprises monitoring discrete steps of the stepper motor.

12. The method of claim 11, wherein the step of determining a change in useful life comprises summing the discrete steps of the stepper motor.

13. The method of claim 9, further comprising the step of monitoring a rotation of at least one of the supply spool and the take-up spool to establish an estimated ribbon cartridge useful life.

14. The method of claim 13, further comprising the step of updating the ribbon cartridge useful life to the estimated ribbon cartridge useful life when the change in useful life is at least one of undefined and inaccurate.

15. The method of claim 9, wherein:
the printer further comprises a display;
the ribbon cartridge memory device further stores a ribbon cartridge capacity; and
the method further comprises the steps of:
determining a remaining percentage of the ribbon cartridge useful life relative to the ribbon cartridge capacity; and
displaying graphically the remaining percentage on the display.

16. A system for monitoring and determining an amount of ribbon on a supply spool used in a printer, comprising:
a ribbon cartridge having a ribbon cartridge memory device storing a ribbon cartridge useful life, the ribbon cartridge further comprising:
a supply spool rotatably coupled to the ribbon cartridge;
a take-up spool rotatably coupled to the ribbon cartridge; and
a ribbon coupled to the supply spool and the take-up spool such that the ribbon can be selectively transferred between the supply spool and the take-up spool;
a printer for receiving the ribbon cartridge, the printer further comprising:
a print head for engaging the ribbon and printing to a print media;
a drive roller for driving the print media upstream and downstream relative to the print head;
a drive motor operationally coupled to at least one of the supply spool, take up spool, and drive roller; and
a controller operationally coupled to the drive motor and the ribbon cartridge memory device;
wherein the controller monitors the drive motor during transfer of the ribbon between the supply spool and the take-up spool to calculate a change in useful life based on rotation of the drive motor and updates the ribbon cartridge useful life by adjusting the ribbon cartridge useful life in accordance with the change in useful life.

17. The system of claim 16, wherein the drive motor is a stepper motor.

18. The system of claim 16, wherein the ribbon cartridge memory device is located on at least one of the supply spool and a housing supporting the supply spool.

19. The system of claim 16, wherein:
the supply spool further includes an encoder wheel; and
the printer includes an optical sensor operationally coupled to the controller and positioned proximate the encoder wheel to monitor the supply spool.

20. The system of claim 19, wherein the encoder wheel is integrally formed with the supply spool.
